(19) United States
(12) Patent Application Publication
(10) Pub. No.: US 2012/0166128 A1
(43) Pub. Date: Jun. 28, 2012

(54) METHOD AND APPARATUS FOR DETECTOR CALIBRATION

(76) Inventors: Abdelazíz Ikhlef, Hartland, WI (US); Jesse David Peplinski, Milwaukee, WI (US)

(21) Appl. No.: 12/979,622

(22) Filed: Dec. 28, 2010

(51) Int. Cl. G01D 18/00

(52) U.S. Cl. 702/104

(57) ABSTRACT

A system for calibrating a pixelated detector includes a detector assembly comprising an array of pixels, an energy source positioned to direct energy toward the array of pixels, a collimating device positioned to pass energy from the energy source to illuminate one pixel, and a data acquisition system (DAS). The DAS is configured to measure a signal in the illuminated one pixel, and measure signals in pixels neighboring the pixel. The system includes a computer programmed to calculate an amount of crosstalk from the illuminated pixel of the pixels neighboring the illuminated pixel based on the measured signals in the DAS, and calculate a crosstalk correction vector for the illuminated pixel based on the measured signal in the illuminated pixel, the measured signals in the pixels neighboring the illuminated pixel, and the calculated amount of crosstalk from the illuminated pixel to each of the pixels neighboring the illuminated pixel.

### BACKGROUND OF THE INVENTION

Embodiments of the invention relate generally to a calibration apparatus and method for a computed tomography (CT) detector module.

Typically, in computed tomography (CT) imaging systems, an x-ray source emits a fan-shaped beam toward a subject or object, such as a patient or a piece of luggage. Hereinafter, the terms “subject” and “object” shall include anything capable of being imaged. The beam, after being attenuated by the subject, impinges upon an array of radiation detectors. The intensity of the attenuated beam radiation received at the detector array is typically dependent upon the attenuation of the x-ray beam by the subject. Each detector element of the detector array produces a separate electrical signal indicative of the attenuated beam received by each detector element. The electrical signals are transmitted to a data processing system for analysis which ultimately produces an image.

Generally, the x-ray source and the detector array are rotated about the gantry within an imaging plane and around the subject. X-ray sources typically include x-ray tubes, which emit the x-ray beam at a focal point. X-ray detectors typically include a collimator for collimating x-ray beams received at the detector and rejecting scatter from the patient, a scintillator for converting x-rays to light energy adjacent the collimator, and photodiodes for receiving the light energy from the adjacent scintillator and producing electrical signals therefrom.

Multi-slice CT scanners are often built with detectors composed of scintillator-photodiode arrays. Typically, a scintillator-photodiode array is formed from a scintillator array that is optically coupled to a photodiode array. The photodiode arrays are mainly based on front-illuminated technology. However, new designs based on back-illuminated photodiodes are being investigated for CT machines to overcome the challenge of the typically higher number of runs and connections. Hence, current CT detectors generally use scintillation crystal/photodiode arrays, where the scintillation crystal absorbs x-rays and converts the absorbed energy into visible light.

The photodiode is used to convert the light to an electric current. Thus, typically each scintillator of a scintillator array converts x-rays to light energy. Each scintillator discharges light energy to a photodiode adjacent and optically coupled thereto. Each photodiode detects the light energy and generates a corresponding electrical signal. The outputs of the photodiodes are then transmitted to a data acquisition system (DAS) for image reconstruction. Readings from the photodiodes are typically proportional to the total energy absorbed in the scintillator.

A CT detector includes tight performance requirements in order to enable the generation of high quality and artifact free CT images. Some of these requirements, as known in the art, are stability of the detector over time and temperature, sensitivity to focal spot motion, light output over life, etc. In a third generation CT scanner, the relative behavior of adjacent channels is typically nearly identical in order to avoid serious ring artifacts (usually defined as channel to channel non-linearity variation). This variation might be affected by the scintillator behavior from one pixel to its neighbor, by the collimator, and by the diode pixel response, to name a few examples. Generally, if these requirements are not met, ring artifacts, bands or smudges might appear in images.

One of the contributors of this channel to channel non-linearity variation (which manifests itself in module to module variation, as well, where a module includes a scintillator-diode array) is the crosstalk generated between the photodiode pixels. Crosstalk has at least four origins: a) x-ray crosstalk due x-ray scattering within the scintillator; b) light crosstalk due to the optical coupler between the diode array and the scintillator array; c) optical crosstalk through septa of the pixilated scintillator; and d) electrical crosstalk between the photodiode pixels. The latter is mainly driven by the lateral diffusion of photocarriers in the silicon and is dependent on the thickness of the diode layer, the properties of the silicon material, and the diode bias present.

There are two types of crosstalk: differential and absolute. Differential crosstalk is the relative difference in crosstalk values across neighboring channel-channel or row-row pairs. These differences can lead to the artifacts described above: rings, bands, and smudges. In addition to the differential crosstalk, absolute crosstalk is the average crosstalk across the detector and impacts spatial resolution, which is mainly defined by a corresponding modulation transfer function (MTF) and single slice profiles (SSP), as known in the art. Absolute crosstalk can also lead to image artifacts.

Crosstalk has two important quality indicators: a) average crosstalk which drives the Modulation Transfer Function (MTF) of the system, and b) differential crosstalk which drives the amount of image quality artifact in the system. Average crosstalk is due in some part to scattered x-ray radiation in the scintillator and to light crosstalk through the reflector septa and the diode-scintillator optical coupler. The differential crosstalk is caused in some part by misalignment that occurs between the diodes and the scintillator arrays. The alignment criteria and requirements are in some cases too stringent, in particular when using a back-illuminated diode. Thus, in order for a detector assembly to pass manufacturing test requirements, modules often have to be removed or swapped in order to pass the image quality specifications for crosstalk.

Therefore, it would be desirable to design an apparatus and method for reducing the effect of crosstalk in CT detector that provides for improved image quality and manufacturability.

### BRIEF DESCRIPTION OF THE INVENTION

The invention is a directed apparatus for calculating a crosstalk correction when calibrating a pixel in an array of pixels.

In accordance with one aspect of the invention, a system for calibrating a pixelated detector includes a detector assembly comprising an array of pixels, an energy source positioned to direct energy toward the array of pixels, a collimating device positioned between the detector assembly and the energy source, and positioned to pass energy from the energy source to illuminate one pixel of the array of pixels, and a data acquisition system (DAS). The DAS is configured to measure a signal in the illuminated one pixel, and measure signals in pixels neighboring the illuminated one pixel. The system includes a computer programmed to calculate an amount of crosstalk from the illuminated one pixel to each pixel of the pixels neighboring the illuminated one pixel based on the measured signals in the DAS, and calculate a crosstalk correction vector for the illuminated one pixel based on the measured signal in the illuminated one pixel, the measured signals in the pixels neighboring the illuminated one pixel, and the calculated amount of crosstalk from the illuminated one pixel to each of the pixels neighboring the illuminated one pixel.

In accordance with another aspect of the invention, a method of calibrating a pixel of a pixelated detector includes illuminating the pixel, measuring a signal in the illuminated pixel, measuring signals in pixels neighboring the illuminated pixel, calculating an amount of crosstalk from the illuminated pixel to each of the pixels neighboring the illuminated pixel, and calculating a crosstalk correction vector for the pixel based on the measured signal in the illuminated pixel, the measured signals in the pixels neighboring the illuminated pixel, and the calculated amount of crosstalk from the illuminated pixel to each of the pixels neighboring the illuminated pixel.

In accordance with yet another aspect of the invention, a computer readable storage medium having stored thereon a program that when executed by a computer causes the computer to acquire a signal of a center pixel within an array of N×N pixels and illuminated with an x-ray source, the signal indicative of an amount of photon energy deposited on a photodiode when it is illuminated by the x-ray source, acquire signals of pixels within the N×N array that are not illuminated by the x-ray source, the signals indicative of an amount of crosstalk from the center pixel to each pixel in the N×N array, calculate a percentage of crosstalk between the center pixel and each pixel in the N×N array based on the acquired signals, and calculate a crosstalk correction vector for the center pixel based on the acquired signal of the center pixel, the acquired signals in the pixels within the N×N array that are not illuminated by the x-ray source, and the calculated percentage of crosstalk between the center pixel and each pixel in the N×N array.

Various other features and advantages will be made apparent from the following detailed description and the drawings.

### BRIEF DESCRIPTION OF THE DRAWINGS

The drawings illustrate preferred embodiments presently contemplated for carrying out the invention.

In the drawings:

FIG. 1 is a pictorial view of a CT imaging system.

FIG. 2 is a block schematic diagram of the system illustrated in FIG. 1.

FIG. 3 is a perspective view of one embodiment of a CT system detector array.

FIG. 4 is a perspective view of a detector module according to an embodiment of the invention.

FIG. 5 illustrates a system for calibrating a pixelated detector.

FIG. 6 is a set of equations corresponding to a 3×3 matrix for pixel calibration, according to an embodiment of the invention.

FIG. 7 is a pictorial view of a CT system for use with a non-invasive package inspection system.

### DETAILED DESCRIPTION

The operating environment of the invention is described with respect to a 256 slice computed tomography (CT) system. However, as will be explained in detail below, the invention is equally applicable for use with other multi-slice configurations such as sixty-four slices, 256 slices, and beyond. Moreover, the invention will be described with respect to the detection and conversion of x-rays. However, one skilled in the art will further appreciate that the invention is equally applicable for the detection and conversion of other high frequency electromagnetic energy. The invention will be described with respect to a “third generation” CT scanner, but is equally applicable with other CT systems.

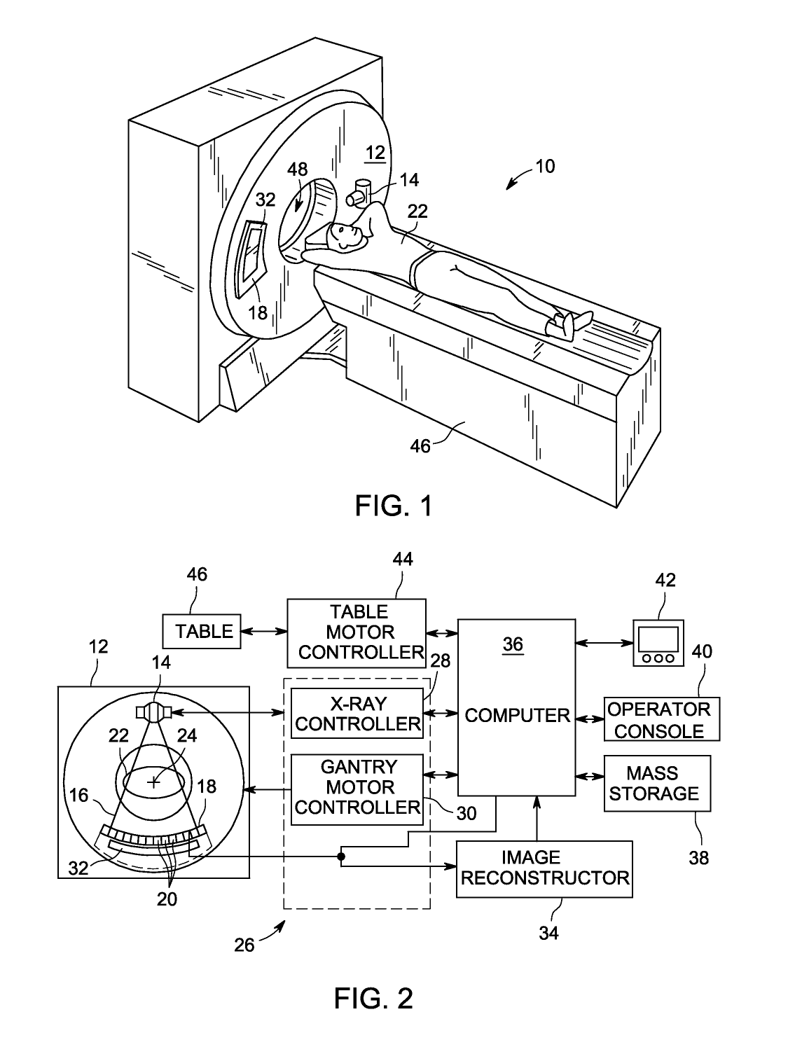

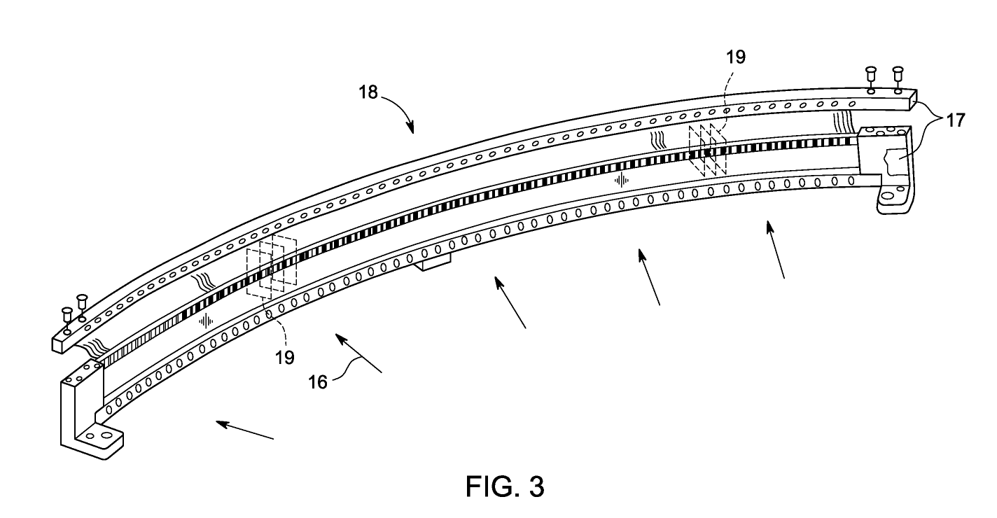

Referring to FIG. 1, a computed tomography (CT) imaging system 10 is shown as including a gantry 12 representative of a “third generation” CT scanner. Gantry 12 has an x-ray source 14 that projects a beam of x-rays toward a detector assembly or collimator 18 on the opposite side of the gantry 12. Referring now to FIG. 2, detector assembly 18 is formed by a plurality of detectors 20 and data acquisition systems (DAS) 32. The plurality of detectors 20 sense the projected x-rays 16 that pass through a medical patient 22, and DAS 32 converts the data to digital signals for subsequent processing. Each detector 20 produces an analog electrical signal that represents the intensity of an impinging x-ray beam and hence the attenuated beam as it passes through the patient 22. During a scan to acquire x-ray projection data, gantry 12 and the components mounted thereon rotate about a center of rotation 24.

Rotation of gantry 12 and the operation of x-ray source 14 are governed by a control mechanism 26 of CT system 10. Control mechanism 26 includes an x-ray controller 28 that provides power and timing signals to an x-ray source 14 and a gantry motor controller 30 that controls the rotational speed and position of gantry 12. An image reconstructor 34 receives sampled and digitized x-ray data from DAS 32 and performs high speed reconstruction. The reconstructed image is applied as an input to a computer 36 which stores the image in a mass storage device 38.

Computer 36 also receives commands and scanning parameters from an operator via console 40 that has some form of operator interface, such as a keyboard, mouse, voice activated controller, or any other suitable input apparatus. An associated display 42 allows the operator to observe the reconstructed image and other data from computer 36. The operator supplied commands and parameters are used by computer 36 to provide control signals and information to DAS 32, x-ray controller 28 and gantry motor controller 30. In addition, computer 36 operates a table motor controller 44 which controls a motorized table 46 to position patient 22 and gantry 12. Particularly, table 46 moves patients 22 through a gantry opening 48 of FIG. 1 in whole or in part.

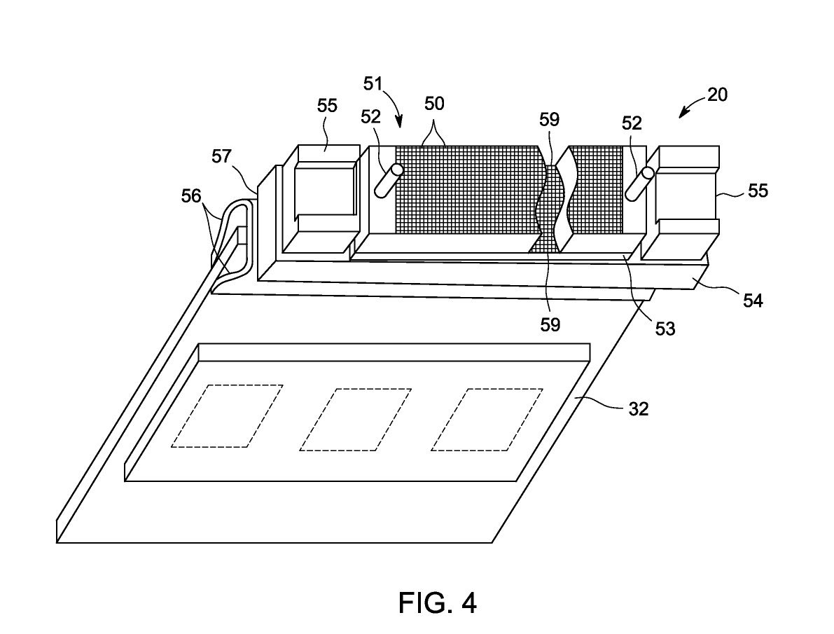

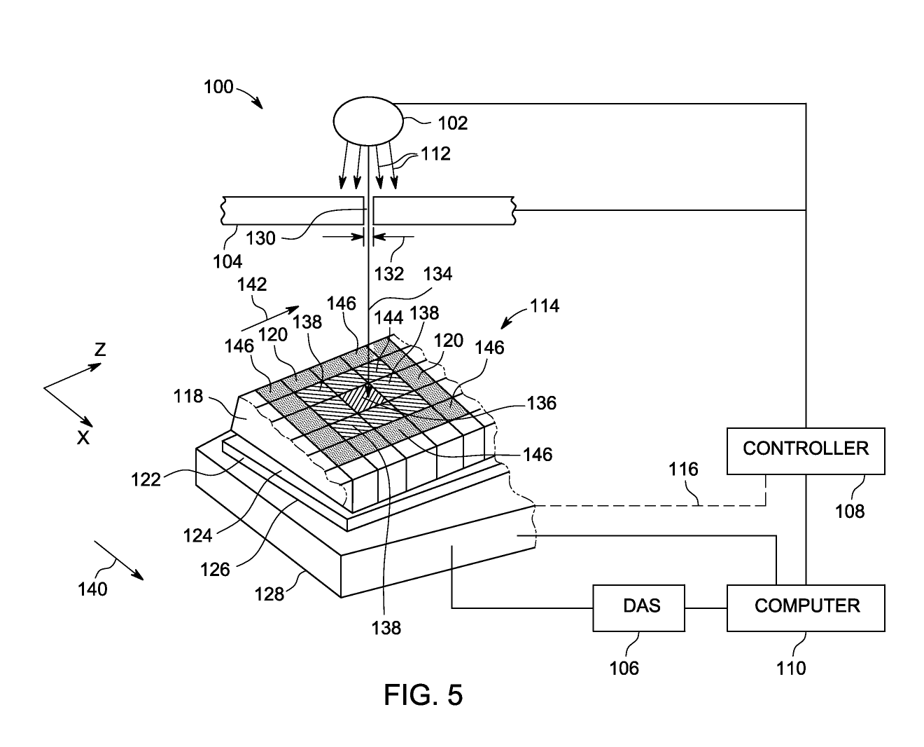

As shown in FIG. 3, detector assembly 18 includes rails 17 having collimating blades or plates 19 placed therebetween. Plates 19 are positioned to collimate x-rays 16 before such beams impinge upon, for instance, detector 20 of FIG. 4 positioned on detector assembly 18. In one embodiment, detector assembly 18 includes 57 detectors 20, each detector 20 having an array size of 64×16 of pixel elements 50. As a result, detector assembly 18 has 64 rows and 912 columns (16×57 detectors) which allows 64 simultaneous slices of data to be collected with each rotation of gantry 12.

Referring to FIG. 4, detector 20 includes DAS 32, with each detector 20 including a number of detector elements 50 arranged in pack 51. Detectors 20 include pins 52 positioned within pack 51 relative to detector elements 50. Pack 51 is positioned on a backlit diode array 53 having a plurality of diodes 59. Backlit diode array 53 is in turn positioned on multi-layer substrate 54. Spacers 55 are positioned on multi-layer substrate 54. Detector elements 50 are optically coupled to backlit diode array 53, and backlit diode array 53 is in turn electrically coupled to multi-layer substrate 54. Flex circuits 56 are attached to face 57 of multi-layer substrate 54 and to DAS 32. Detectors 20 are positioned within detector assembly 18 by use of pins 52.

In the operation of one embodiment, x-rays impinging within detector elements 50 generate photons which traverse pack 51, thereby generating an analog signal which is detected on a diode within backlit diode array 53. The analog signal generated is carried through multi-layer substrate 54, through flex circuits 56, to DAS 32 wherein the analog signal is converted to a digital signal.

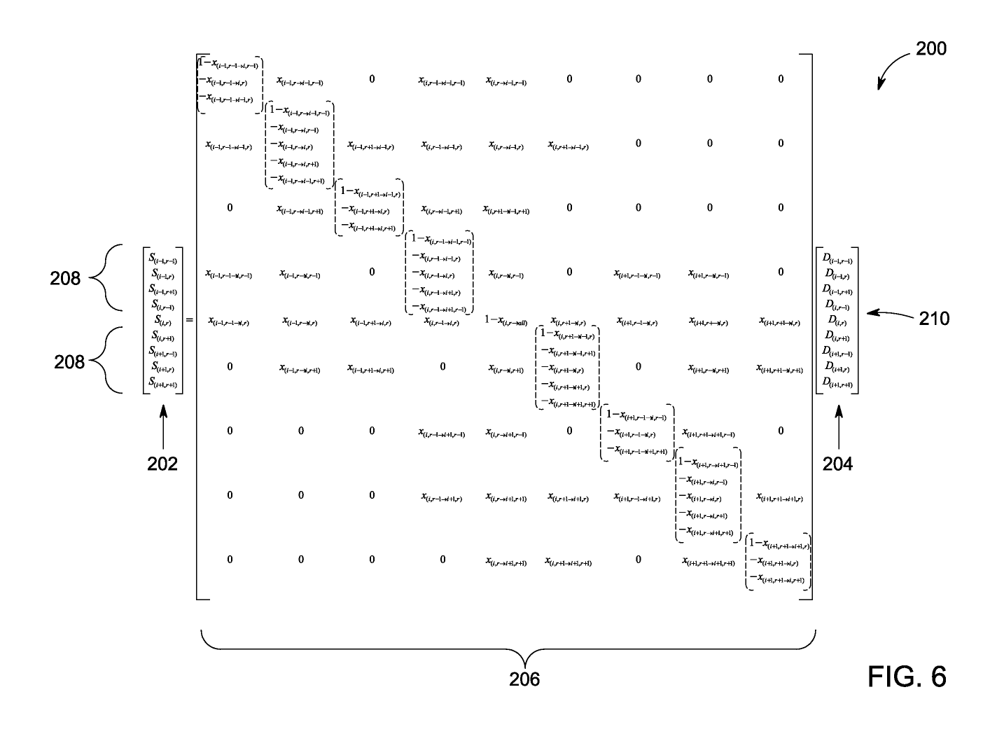

Referring now to FIG. 5, a system 100 for calibrating a pixelated detector includes an energy source 102, a collimating device 104, a data acquisition system (DAS) 106, a controller 108, and a computer 110. In one embodiment, energy source 102 is an x-ray source configured to emit x-rays 112. However, it is to be understood that the method and apparatus disclosed herein is not limited to a system using an x-ray source, but applicable to any system having an array of detectors that may experience crosstalk in a detector.

DAS 106 is coupleable to a detector module 114 and DAS 106 is configured to receive electrical signals therefrom in order to process the electrical signals and pass output therefrom to computer 110. Computer 110 is coupled to controller 108, which is in turn coupled to collimator 104 and energy source 102. In one embodiment, computer 110 is coupled 116 to detector module 114 in order to position detector module 114 during a calibration process. Collimating device 104 is positioned such that x-rays 112 that emit from energy source 102 and toward detector module 114 are intercepted and absorbed thereby.

Detector module 114 includes a pack or scintillator array 118 having scintillator pixels 120. Detector module 114 includes a photodiode array 122 having photodiodes (not shown), and scintillator array 118 is optically coupled to photodiode array 122, according to an embodiment (optical coupler not shown). In the embodiment illustrated, photodiode array 122 includes a plurality of backlit diodes that are configured to receive optical signals on a top surface 124 thereof, and pass an electrical charge that is generally proportional thereto to a backside 126 thereof. As such, scintillator array 118 and photodiode array 122 form a scintillator-photodiode array. Detector module 114 includes a readout element 128 that is configured to receive electrical signals from photodiode 122 and pass the signals to DAS 106. In one embodiment readout element 128 includes a multilayer device that may comprise a ceramic such as alumina or aluminum nitride, the multilayer device comprising metal interconnects that route signals from pixels of detector module 114 to DAS 106. However, it is to be understood that embodiments of the invention may include a device that does not include readout element 128, for instance, and signals may pass directly from photodiode 122 to DAS 106 instead of passing through readout element 128.

Thus, detector module 114 may be similar to that described above with respect to FIG. 4. However, it is also contemplated that any detector array having pixelated elements may be applicable to the invention described herein. That is, other scintillator-photodiode combinations may be calibrated for crosstalk according to embodiments of the invention. For instance, photodiode 122 may be a frontlit diode array having a scintillator array positioned thereon, the frontlit photodiode array configured to carry electrical signals on a surface thereof that is positioned between the frontlit diode and the scintillator array, as is known in the art.

Collimating device 104 includes a pinhole or slit 130 positioned therein having a diameter or width 132. Pinhole or slit 130 is positioned and diameter 132 is selected based on a desire to enable illumination of only one pixel of scintillator array 118 with x-rays. Pinhole or slit 130 is formed in both X and Z dimensions of detector module 114. Thus, as known in the art, diameter 132 is selected based on parameters that include but are not limited to size of each pixel 120, a distance from energy source 102 to detector module 114, a distance from energy source 102 to collimating device 104, and the like.

In operation, energy source 102 is caused to generate x-rays 112 toward detector module 114, some of which pass 134 through pinhole or slot 130 of collimating device 104 to illuminate a pixel 136. When pixel 136 is illuminated by x-rays 134, pixels 138 that are immediately adjacent and diagonal to pixel 136 also have charge generated, as a result of crosstalk between the illuminated pixel 136 and neighboring pixels 138. Thus, crosstalk from each neighboring pixel 138 may be detected or measured in DAS 106 and acquired by computer 110. As such, pixel 136 and neighboring pixels 138, in one embodiment, comprise a 3×3 matrix of pixels that may be used to determine or calculate a crosstalk correction vector for the illuminated pixel 136, according to an embodiment of the invention.

In order to achieve this correction, crosstalk of each pixel to its eight neighbors may be measured, for instance, in a pretest bay during manufacture of detector module 114. Thus, referring to FIG. 5, a crosstalk correction vector may be determined for scintillator pixels 136 by measuring crosstalk in neighbors 138. The measurement is performed using pinhole or slit 130 of collimating device 104 to illuminate only pixel 136 to measure a signal received by neighboring pixels 138. Thus, for pixel 136, crosstalk to eight surrounding pixels 138 is measured.

In Table 1 below, pixel 136 is represented by P(ch, R), and measurements in neighboring pixels 138 are represented, correspondingly, as channels ‘ch’ and rows ‘R’ relative to pixel 136. Channels ‘ch’ may correspond to a channel direction 140, and rows ‘R’ may correspond to a row direction 142, illustrated in FIG. 5. Thus, in one example to illustrate the ‘ch’ and ‘R’ terminology, pixel P(ch-1, R+1) corresponds to pixel 144 and is a diagonal pixel with respect to pixel 136 that is at P(ch, R). Thus, ch and R correspond to channel and row of the pixel.

TABLE 1

| | P(ch − | P(ch − | P(ch − | P(ch, R − | | P(ch + 1, R − | | |
|---|---|---|---|---|---|---|---|---|
| P(ch, R) | 1, R − 1) | 1, R) | 1, R + 1) | 1) | P(ch, R + 1) | 1) | P(ch + 1, R) | P(ch + 1, R + 1) |
| Pixel | XT %→ | XT %→ | XT %→ | XT %→ | XT %→ | XT %→ | XT %→ | XT %→ |
| (ch, R) | P(ch − | P(ch − | P(ch − | P(ch, R − | P(ch, R + 1) | P(ch + 1, R − | P(ch + 1, R) | P(ch + 1, R + 1) |
| | 1, R − 1) | 1, R) | 1, R + 1) | 1) | | 1) | | |

Referring still to Table 1, crosstalk to each pixel may be calculated once signals in pixel 136 and neighboring pixels 138 are measured. That is, when pixel 136 is illuminated, measurement in all pixels of the 3×3 matrix may be acquired by DAS 106. Percent crosstalk, or XT % illustrated in Table 1, may be calculated by first determining a total crosstalk to each of the neighboring pixels 138, and then determining a percentage of crosstalk to each respective pixel of scintillator pixels 138 based on the measured value in each with respect to the calculated total crosstalk.

The data may be represented in a matrix form and input to a system of equations, as known in the art. In one embodiment, it is assumed that most crosstalk comes mainly from the nearest neighboring cells 138, and the problem is constrained to a 3×3 array deconvolution solution [S]=[A].[D]. Thus, in this embodiment, measurement in pixel 136 and neighboring pixels 138 may form the basis for crosstalk correction vector D.

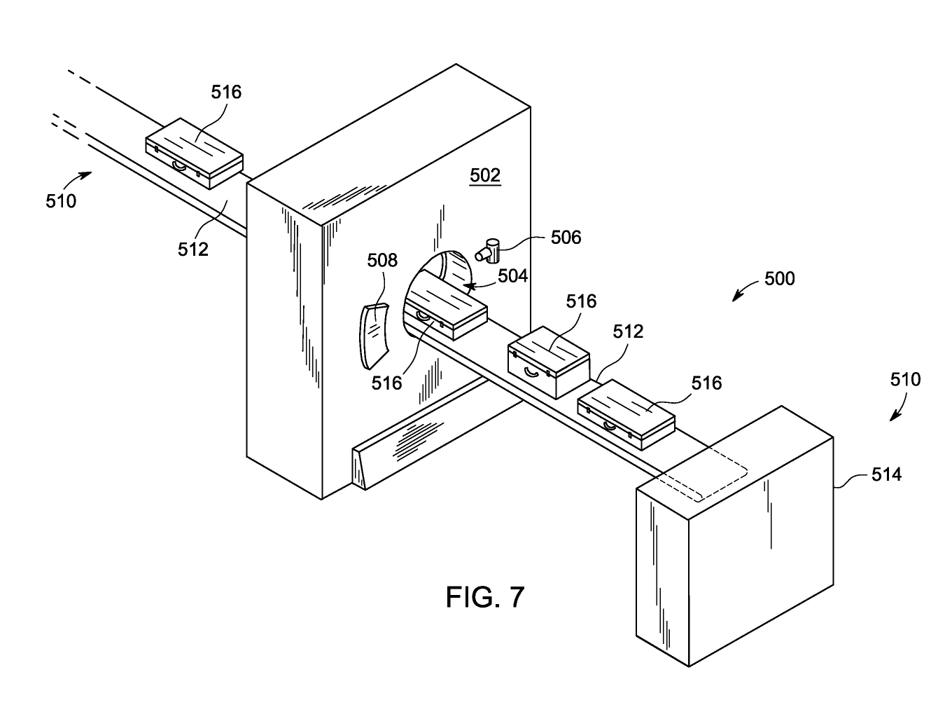

Referring now to FIG. 6, a set of equations 200 for a 3×3 array of pixels is shown that represents the vector S 202 which is the measured signal for every pixel, the vector D 204 represents the signal of every pixel with crosstalk correction (crosstalk removed), and the array or matrix A 206 represents the coefficients of the matrix composed of real crosstalk vectors. That is, vector S 202 represents measured values of pixel 136 (S_{(i,r)}) and measured values of neighboring pixels 138 correspond to the additional elements 208 of vector S 202. Further, elements of array A 206 also are calculated based on percentage crosstalk values that are determined in the fashion previously described. The goal is to solve the system of equations in order to find vector D 204, which includes D(i,r) 210 and corresponding values of the pixel (ch,r) without crosstalk. This process may be repeated for all pixels of the detector, resulting in a crosstalk correction vector for each pixel in detector module 114.

In other words, x-rays may be directed specifically toward a first pixel, such as pixel 136 of FIG. 5, and limited by collimating device 104 such that neighboring pixels 138 are not illuminated. Signal is measured in the illuminated pixel 136 as well as in neighboring pixels 138. Crosstalk is calculated between pixel 138 and each of the neighboring pixels 138 for a condition when only pixel 136 is illuminated. As illustrated, vector S 202 and array A 206 may be filled, and via known mathematical techniques, vector 204 may be solved in order to obtain vector D. Controller 108 may then cause another pixel of scintillator pixels 120 to be illuminated, and the process may be repeated and vector 204 may be solved in order to obtain vector D that corresponds to the another pixel that is illuminated. In such fashion, the entire set of pixels 120 may be calibrated for crosstalk correction according to the invention, each pixel having a vector D associated therewith and corresponding coefficients.

As such, in relation to the described 3×3 solution, a calibration device such as system 100 for calibrating a pixel may be used to calculate a percent crosstalk to each neighbor of a given pixel. Once an amount of crosstalk is measured and percent crosstalk to each neighboring pixel is calculated, a computing device may be employed or utilized to invert the matrix of the equation in FIG. 6. This results in a vector D having correction coefficients for the pixel being calibrated, which includes 9 coefficients for a 3×3 array of pixels (pixel 136 and eight neighboring pixels 138 of FIG. 5). Thus, once calibration of each pixel is complete, a corresponding correction vector D having nine coefficients may be determined for each pixel within an array of pixels, and applied during subsequent scanning by multiplying with measured pixel signals to give corrected or “true” values for each respective pixel.

The above embodiment includes a 3×3 matrix for obtaining data for crosstalk correction. However, the invention described herein is not to be so limited, and second-order crosstalk might also be considered to add additional accuracy to the solution. That is, referring to FIG. 5, additional pixels 146 that are two rows and channels removed from pixel 136 may be used to account for second-order crosstalk effects. Thus, in this embodiment a 5×5 matrix may be generated and solved in the same fashion as described for the 3×3 solution above. In the case of a 5×5 array, vectors S and D include 25 elements each, and array A will have dimensions of 25×25, as shown in Eqn. 1:

$$[ \begin{matrix}S ( ch - 2 , r - 2 ) \\ ⋮ \\ ⋮ \\ S ( ch , r ) \\ ⋮ \\ ⋮ \\ S ( ch + 2 , r + 2 )\end{matrix} ] [ \begin{matrix}{C}_{1 , 1} & … & … & … & … & … & {c}_{1 , 25} \\ … & … & … & … & … & … & … \\ … & … & … & … & … & … & … \\ … & … & … & … & … & … & … \\ … & … & … & … & … & … & … \\ … & … & … & … & … & … & … \\ {C}_{25 , 1} & … & … & … & … & … & {C}_{25 , 25}\end{matrix} ] [ \begin{matrix}D ( ch - 2 , r - 2 ) \\ ⋮ \\ ⋮ \\ D ( ch , r ) \\ ⋮ \\ ⋮ \\ D ( ch + 2 \cdot r + 2 )\end{matrix} ] . \qquad Eqn . 1$$

As known in the art, this matrix could be simplified to a 3×3 array, corresponding mathematically to the 9×9 deconvolution as shown in FIG. 6.

Further, 3×3 matrices and 5×5 matrices have been illustrated that correspond respectively to measurements using neighboring pixels only (3×3) and using values measured in pixels that are two pixels away from a pixel being calibrated (5×5). However, the invention is not so limited and may be applicable to any N×N matrix to take advantage of yet additional measurements to account for higher order effects. Such solutions may be obtained according to the invention, with the tradeoff that additional mathematical complexity is introduced into the solution for increasing matrix size.

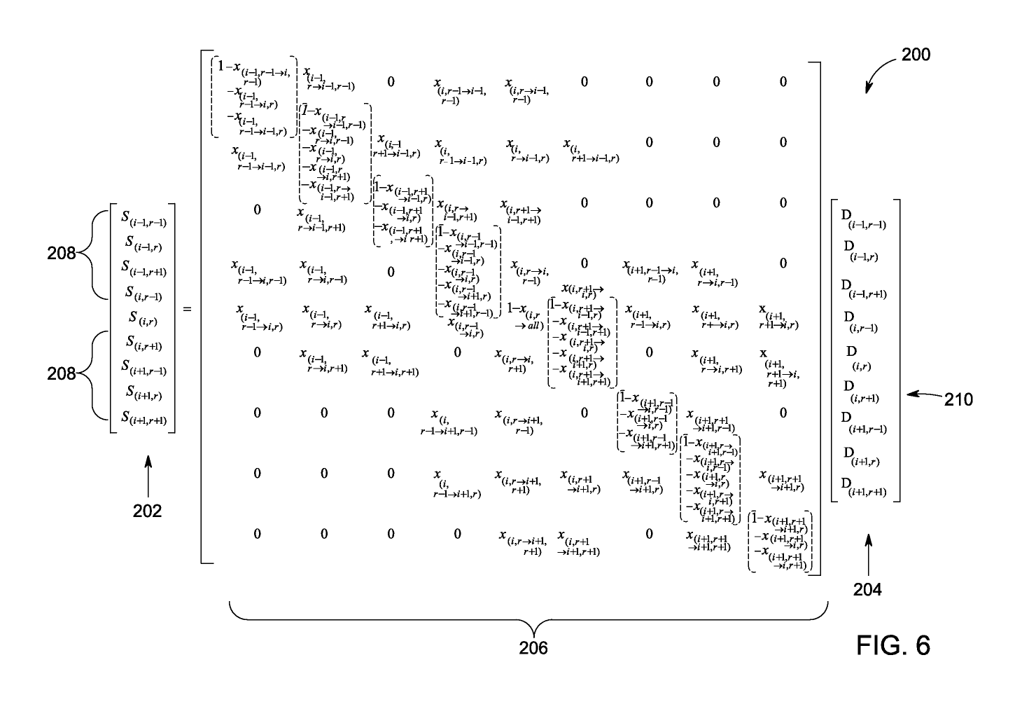

Referring now to FIG. 7, package/baggage inspection system 500 includes a rotatable gantry 502 having an opening 504 therein through which packages or pieces of baggage may pass. The rotatable gantry 502 houses a high frequency electromagnetic energy source 506 as well as a detector assembly 508 having detector modules 20 similar to that shown in FIG. 4. A conveyor system 510 is also provided and includes a conveyor belt 512 supported by structure 514 to automatically and continuously pass packages or baggage pieces 516 through opening 504 to be scanned. Objects 516 are fed through opening 504 by conveyor belt 512, imaging data is then acquired, and the conveyor belt 512 removes the packages 516 from opening 504 in a controlled and continuous manner. As a result, postal inspectors, baggage handlers, and other security personnel may non-invasively inspect the contents of packages 516 for explosives, knives, guns, contraband, etc.

A technical contribution for the disclosed method and apparatus is that it provides for a computer implemented calibration apparatus and method for a computed tomography (CT) detector module.

One skilled in the art will appreciate that embodiments of the invention may be interfaced to and controlled by a computer readable storage medium having stored thereon a computer program. The computer readable storage medium includes a plurality of components such as one or more of electronic components, hardware components, and/or computer software components. These components may include one or more computer readable storage media that generally stores instructions such as software, firmware and/or assembly language for performing one or more portions of one or more implementations or embodiments of a sequence. These computer readable storage media are generally non-transitory and/or tangible. Examples of such a computer readable storage medium include a recordable data storage medium of a computer and/or storage device. The computer readable storage media may employ, for example, one or more of a magnetic, electrical, optical, biological, and/or atomic data storage medium. Further, such media may take the form of, for example, floppy disks, magnetic tapes, CD-ROMs, DVD-ROMs, hard disk drives, and/or electronic memory. Other forms of non-transitory and/or tangible computer readable storage media not list may be employed with embodiments of the invention.

A number of such components can be combined or divided in an implementation of a system. Further, such components may include a set and/or series of computer instructions written in or implemented with any of a number of programming languages, as will be appreciated by those skilled in the art. In addition, other forms of computer readable media such as a carrier wave may be employed to embody a computer data signal representing a sequence of instructions that when executed by one or more computers causes the one or more computers to perform one or more portions of one or more implementations or embodiments of a sequence.

Therefore, according to one embodiment of the invention, a system for calibrating a pixelated detector includes a detector assembly comprising an array of pixels, an energy source positioned to direct energy toward the array of pixels, a collimating device positioned between the detector assembly and the energy source, and positioned to pass energy from the energy source to illuminate one pixel of the array of pixels, and a data acquisition system (DAS). The DAS is configured to measure a signal in the illuminated one pixel, and measure signals in pixels neighboring the illuminated one pixel. The system includes a computer programmed to calculate an amount of crosstalk from the illuminated one pixel to each pixel of the pixels neighboring the illuminated one pixel based on the measured signals in the DAS, and calculate a crosstalk correction vector for the illuminated one pixel based on the measured signal in the illuminated one pixel, the measured signals in the pixels neighboring the illuminated one pixel, and the calculated amount of crosstalk from the illuminated one pixel to each of the pixels neighboring the illuminated one pixel.

According to another embodiment of the invention, a method of calibrating a pixel of a pixelated detector includes illuminating the pixel, measuring a signal in the illuminated pixel, measuring signals in pixels neighboring the illuminated pixel, calculating an amount of crosstalk from the illuminated pixel to each of the pixels neighboring the illuminated pixel, and calculating a crosstalk correction vector for the pixel based on the measured signal in the illuminated pixel, the measured signals in the pixels neighboring the illuminated pixel, and the calculated amount of crosstalk from the illuminated pixel to each of the pixels neighboring the illuminated pixel.

According to yet another embodiment of the invention, a computer readable storage medium having stored thereon a program that when executed by a computer causes the computer to acquire a signal of a center pixel within an array of N×N pixels and illuminated with an x-ray source, the signal indicative of an amount of photon energy deposited on a photodiode when it is illuminated by the x-ray source, acquire signals of pixels within the N×N array that are not illuminated by the x-ray source, the signals indicative of an amount of crosstalk from the center pixel to each pixel in the N×N array, calculate a percentage of crosstalk between the center pixel and each pixel in the N×N array based on the acquired signals, and calculate a crosstalk correction vector for the center pixel based on the acquired signal of the center pixel, the acquired signals in the pixels within the N×N array that are not illuminated by the x-ray source, and the calculated percentage of crosstalk between the center pixel and each pixel in the N×N array.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A system for calibrating a pixelated detector, the system comprising:
a detector assembly comprising an array of pixels;
an energy source positioned to direct energy toward the array of pixels;
a collimating device positioned between the detector assembly and the energy source, and positioned to pass energy from the energy source to illuminate one pixel of the array of pixels;
a data acquisition system (DAS) configured to:
measure a signal in the illuminated one pixel; and
measure signals in pixels neighboring the illuminated one pixel; and
a computer programmed to:
calculate an amount of crosstalk from the illuminated one pixel to each pixel of the pixels neighboring the illuminated one pixel based on the measured signals in the DAS; and
calculate a crosstalk correction vector for the illuminated one pixel based on:
the measured signal in the illuminated one pixel;
the measured signals in the pixels neighboring the illuminated one pixel; and
the calculated amount of crosstalk from the illuminated one pixel to each of the pixels neighboring the illuminated one pixel.

2. The system of claim 1 wherein the computer is programmed to calculate the amount of crosstalk from the illuminated one pixel to each pixel of the pixels neighboring the illuminated one pixel by being programmed to:
calculate a total amount of crosstalk by summing signals in the pixels neighboring the illuminated one pixel;
determine a percentage crosstalk from the illuminated one pixel to each of the pixels neighboring the illuminated one pixel based on:
the measured signals in the pixels neighboring the illuminated one pixel; and
the total amount of crosstalk; and
express the calculated amount of crosstalk as the determined percentage with respect to each of the pixels neighboring the illuminated one pixel.

3. The system of claim 1 wherein the detector assembly comprises a scintillator-photodiode array.

4. The system of claim 3 wherein the scintillator-photodiode array comprises a backlit photodiode.

5. The system of claim 1 wherein the energy source is an x-ray source.

6. The system of claim 1 wherein the pixels neighboring the illuminated one pixel comprise eight pixels immediately adjacent and diagonal to the illuminated one pixel, the measured signal and the measured signals resulting in a 3×3 matrix.

7. The system of claim 1 wherein the pixels neighboring the illuminated one pixel comprise 24 pixels and the illuminated one pixel in a 5×5 matrix with the illuminated one pixel as a center of the 5×5 matrix.

8. The system of claim 1 wherein the collimating device comprises one of a slit and a hole.

9. The system of claim 1 wherein the computer is programmed to calculate the crosstalk correction vector for the illuminated one pixel by being programmed to:
generate a vector S that is comprised of:
the measured signal in the illuminated one pixel;
the measured signals in the pixels neighboring the illuminated one pixel;
generate a matrix A comprised of the calculated amount of crosstalk from the illuminated one pixel to each of the pixels neighboring the illuminated one pixel; and
solve for vector [D]=[S][A]⁻¹.

10. A method of calibrating a pixel of a pixelated detector comprising:
illuminating the pixel;
measuring a signal in the illuminated pixel;
measuring signals in pixels neighboring the illuminated pixel;
calculating an amount of crosstalk from the illuminated pixel to each of the pixels neighboring the illuminated pixel; and
calculating a crosstalk correction vector for the pixel based on:
the measured signal in the illuminated pixel;
the measured signals in the pixels neighboring the illuminated pixel; and
the calculated amount of crosstalk from the illuminated pixel to each of the pixels neighboring the illuminated pixel.

11. The method of claim 10 wherein illuminating the pixel comprises illuminating the pixel with an x-ray source.

12. The method of claim 10 wherein measuring the signal in the illuminated pixel comprises measuring the signal with a scintillator-photodiode array.

13. The method of claim 12 wherein the scintillator-photodiode array comprises a backlit photodiode.

14. The method of claim 10 wherein calculating the crosstalk correction vector comprises:
summing the measured signals in the pixels neighboring the illuminated pixel;
determining a percentage crosstalk in each of the neighboring pixels based on the sum of the measured signals;

15. The method of claim 10 wherein the illuminated pixel and the neighboring pixels comprise one of a 3×3 matrix and a 5×5 matrix.

16. A computer readable storage medium having stored thereon a program that when executed by a computer causes the computer to:
acquire a signal of a center pixel within an array of N×N pixels and illuminated with an x-ray source, the signal indicative of an amount of photon energy deposited on a photodiode when it is illuminated by the x-ray source;
acquire signals of pixels within the N×N array that are not illuminated by the x-ray source, the signals indicative of an amount of crosstalk from the center pixel to each pixel in the N×N array;
calculate a percentage of crosstalk between the center pixel and each pixel in the N×N array based on the acquired signals; and
calculate a crosstalk correction vector for the center pixel based on:
the acquired signal of the center pixel;
the acquired signals in the pixels within the N×N array that are not illuminated by the x-ray source; and
the calculated percentage of crosstalk between the center pixel and each pixel in the N×N array.

17. The computer readable storage medium of claim 16 wherein the N×N array comprises one of a 3×3 array and a 5×5 array.

18. The computer readable storage medium of claim 17 wherein the computer is caused to:
generate a vector S that is comprised of:
the acquired signal of the center pixel;
the acquired signals of pixels within the N×N array;
generate a matrix A that is comprised of the calculated percentage of crosstalk between the center pixel and each pixel in the N×N array; and
solve for vector [D]=[S][A]⁻¹.

19. The computer readable storage medium of claim 18 wherein the computer is caused to store the crosstalk correction vector for the center pixel based on the vector D.

20. The computer readable storage medium of claim 16 wherein the computer is caused to calculate the percentage crosstalk between the center pixel and each pixel in the N×N array based on a sum of signals acquired pixels in the N×N array that are not illuminated by the x-ray source.
